(19) United States
(12) Patent Application Publication
(10) Pub. No.: US 2025/0072659 A1
(43) Pub. Date: Mar. 6, 2025

(54) AIR-FLOW COOKING APPLIANCE

(71) Applicant: KARACA ZÜCCACIYE TICARET VE SANAYI ANONIM SIRKETI, Istanbul (TR)

(72) Inventor: Muzaffer KARACA, Istanbul (TR)

(21) Appl. No.: 18/575,209

(22) PCT Filed: Jun. 12, 2023
(86) PCT No.: PCT/TR2023/050550

§ 371 Date: Dec. 28, 2023

(30) Foreign Application Priority Data
Dec. 16, 2022 (TR) 2022/019476

(51) Int. Cl. A47J 37/06; A23C 9/12; A47J 36/32; F24C 15/32

(52) U.S. Cl. CPC A47J 37/0641; A23C 9/1226; A47J 36/32; A47J 37/0664; F24C 15/322

(57) ABSTRACT

The invention relates to a hot-air cooking appliance comprising a cooking chamber (4) in which the products to be cooked are placed, a fat collector (3) placed on the bottom of the cooking chamber (4) and a keypad (5) for selecting and adjusting the cooking options, characterized in that it comprises a pot (2) placed on the fat collector (3) in which the ingredients required for the preparation of stews and yogurt are added, and a controller for adjusting the operating temperature and time interval for the cooking of stews and yogurt preparation functions.

### TECHNICAL FIELD

The invention relates to a hot-air cooking appliance for cooking stews and making yogurt, which provides acoustic information.

### STATE OF THE ART

Hot-air cooking appliances are convection/heat-transfer ovens that use a fan to circulate hot air inside to cook food. Food is cooked with the help of this heat transfer. As the hot air stream touches all parts of the food, the food is cooked to the desired level with less oil.

Air-flow cooking appliances are equipped with a perforated wire basket through which the air can circulate in the appliance. The food is placed in this basket so that the air stream comes into contact with the food. Thanks to the specified air circulation, food is cooked in a shorter time. The appliance is equipped with a timer. After setting the temperature and cooking time according to the food to be cooked, the appliance switches off automatically. So it is not necessary to constantly check whether the food is cooked.

In the state of the art, thanks to the developed intelligent system, the products placed in the appliance are recognized and the cooking temperature and time are automatically determined and monitored. The mentioned appliances are capable of heating, frying and grilling food.

During the search in the state of the art, application CN112753764A was found. The application relates to an airflow cooking appliance with the ability to prepare yogurt. However, the appliance in question does not have the feature of cooking stews and having an audible warning.

During a further search in the state of the art, application number KR20220019554A was found. The application relates to an appliance that carries out the cooking process by determining the product type of the object to be cooked. The aforementioned airflow-powered appliance provides stews and voice information. However, the appliance in question does not have the yogurt preparation feature.

In conclusion, the aforementioned disadvantages and the inadequacy of existing solutions necessitated a technical innovation.

### Purpose of Invention

The invention has been inspired by current situations and is intended to solve the above-mentioned problems.

The main object of the invention is to provide a hot air cooking appliance having the features of cooking stews and making yogurt.

The purpose of the invention is to inform the user that the products placed inside are cooked with an audible warning.

The object of the invention is to provide drying of the vegetables and fruits placed therein.

A further object of the invention is to provide a fat-free frying process.

In order to achieve the above purposes, the invention relates to a hot air cooking appliance comprising a cooking chamber into which the products to be cooked are placed, a fat collector at the bottom of the cooking chamber and a keypad for selecting the cooking options. It comprises a pot, into which the ingredients required for the preparation of stews and yogurt are placed, a controller with which the operating temperature can be set to 150° C.-210° C., time interval 1-120 minutes for cooking stews and 35° C.-55° C., time interval 5-10 hours for yogurt preparation.

The structural and characteristic features and advantages of the said invention may be understood in a better way by means of the following drawings, figures, and detailed description that includes references to the said figures. Therefore, the evaluation should be made by taking these figures and detailed description into consideration.

### DESCRIPTION OF FIGURES

FIG. 1 is a view of the parts of the appliance subject to the invention.

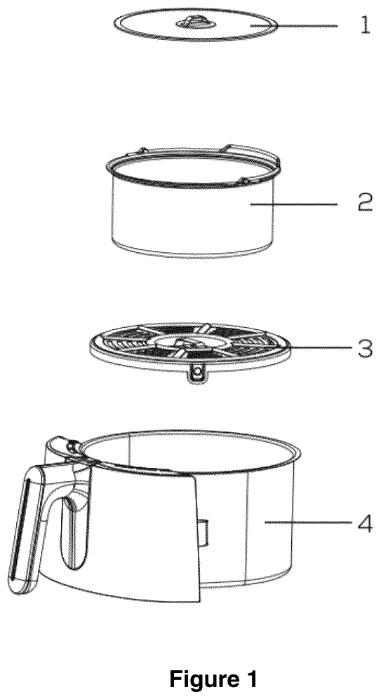

FIG. 2 is a general view of the appliance subject to the invention.

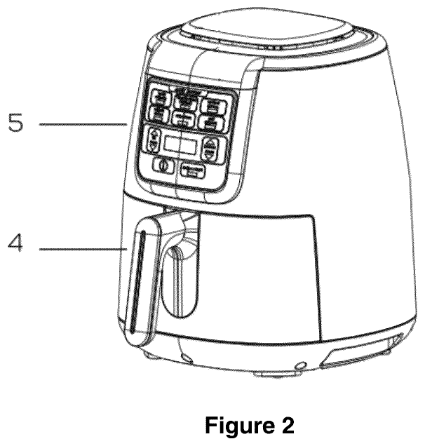

### DESCRIPTION OF REFERENCED PARTS

1. Lid
2. Pot
3. Fat collector
4. Cooking chamber
5. Keypad

### DETAILED DESCRIPTION OF THE INVENTION

The preferred embodiments of the configuration of the invention described herein are disclosed as non-limiting descriptions of the invention and intended only for better understanding of the subject matter.

In general, the appliance according to the invention comprises a cooking chamber (4) in which the products to be cooked are placed, a fat collector (3) placed on the bottom of the cooking chamber (4), a pot (2) placed on the fat collector (3), which enables the cooking of stews and making yogurt, a keypad (5) which enables the cooking options to be selected and adjusted and a lid (1). The controller is used to set the operating temperature and time interval for the cooking of stews and yogurt preparation functions.

There are selection buttons on the keypad (5) where functional cooking options are selected and set. These are; Home Cooking, Oven/Grill, Heating, Yogurt Preparation, Vegetable/Fruit Drying, Air Fry options.
1. Home Cooking: It provides cooking of stew recipes.
2. Oven/Grill: It is used when the barbecue function is to be activated. Meat, chicken, fish can be cooked using the specified function. Pastries are also cooked in this function.
3. Heating: It provides heating of food. It can also be used for preheating process.
4. Yogurt preparation: The home cooking pot (2) is used to make home yogurt.
5. Air Fry: The frying process can be carried out with or without oil.
6. Vegetable/Fruit Drying: The drying of vegetables and fruits is carried out to obtain healthy snacks.

There are also buttons on the keypad (5) for manually setting the cooking temperature and time before cooking. In addition, there are time buttons, start/stop buttons, power button and standby mode button on the keypad (5). The buttons on the keypad (5) can be used to update the temperature during cooking. For example; when the appliance starts to operate at 200° C. and 20 minutes in Air fryer mode, the temperature parameter can be changed at any time of the operation with the temperature button on the keypad (5), so that only the temperature is set without changing the time remaining for cooking the food.

The fat collector (3) must be inserted into the cooking chamber (4) for the appliance to operate. After performing the aforementioned operation, the cooking function is selected on the keypad (5). Depending on the selected cooking function, the default temperature setting is displayed on the screen on the keypad (5). The desired temperature setting can be increased or decreased with the temperature adjustment buttons located next to the screen. After the temperature setting, the time setting can also be adjusted using the time adjustment buttons.

The products to be cooked are placed in the cooking chamber (4). The cooking chamber (4) must then be inserted into the appliance. The cooking process is started by pressing the start/stop button on the keypad (5). The start of the cooking process is also shared with the user as an audible warning by means of the speaker on the appliance. The remaining cooking time can be monitored on the screen.

After the cooking process is completed, it is indicated on the screen that the cooking process is completed. In addition, the user is also informed with an audible warning.

Pots (2) are used for cooking stews and making yogurt.

### Yogurt Preparation

The fat collector (3) must be inserted into the cooking chamber (4) for the appliance to operate. After performing the aforementioned operation, select the “Yogurt Preparation” function on the keypad (5). Depending on the selected cooking function, the default temperature setting is displayed on the screen on the keypad (5). The desired temperature setting can be increased or decreased with the temperature adjustment buttons located next to the screen. After the temperature setting, the time setting can also be adjusted using the time adjustment buttons. The operating temperature for yogurt making is configured as 35° C.-55° C. The time interval is set as 5-10 hours. The aforementioned adjustments are carried out by means of the controller in the appliance. The fan does not operate in the yogurt preparation function, only the heater function is activated by the controller.

The ingredients required for yogurt preparation are added into the pot (2). The pot (2) is then placed into the cooking chamber (4) and covered with the splash-proof lid (1).

The cooking process is started by pressing the start/stop button on the keypad (5). The start of the cooking process is also shared with the user as an audible warning by means of the speaker on the appliance. The remaining cooking time can be monitored on the screen.

After the cooking process is completed, it is indicated on the screen that the cooking process is completed. In addition, the user is also informed with an audible warning.

### Stew Preparation

The fat collector (3) must be inserted into the cooking chamber (4) for the appliance to operate. After performing the aforementioned operation, select the “Home Cooking” function on the keypad (5). Depending on the selected cooking function, the default temperature setting is displayed on the screen on the keypad (5). The desired temperature setting can be increased or decreased with the temperature adjustment buttons located next to the screen. After the temperature setting, the time setting can also be adjusted using the time adjustment buttons. It is configured so that the operating temperature is 150° C.-210° C. for the stew cooking feature. The time interval is set as 1-120 min. The aforementioned adjustments are carried out by means of the controller in the appliance. By keeping the range of the operating time wide, it is ensured that the stewing function is achieved.

The ingredients required for the preparation of the stew are added into the pot (2). The pot (2) is then placed into the cooking chamber (4) and covered with the splash-proof lid (1).

The stew cooking process is started by pressing the start/stop button on the keypad (5). The start of the cooking process is also shared with the user as an audible warning by means of the speaker on the appliance. The remaining cooking time can be monitored on the screen.

The notification that the food should be stirred within the specified time is transmitted to the user as an audible warning. According to a preferred embodiment of the invention, an audible warning about stirring the food is shared every 5 minutes.

After the cooking process is completed, it is indicated on the screen that the cooking process is completed. In addition, the user is also informed with an audible warning.

The following table shows the temperature and time intervals of the functions.

TABLE 1
Temperature and Duration Ranges of Functions

| FUNCTION | SELECTION | TEMPERATURE | TIME | |
|---|---|---|---|---|
| Home Cooking | Automatic Selection | 210° C. | 120 | min |
| | Manuel Selection | 150° C.-210° C. | 1 min-120 min | |
| Grill/Oven | Automatic Selection | 190° C. | 15 | min |
| | Manuel Selection | 120° C.-210° C. | 1 min-240 min | |
| Heating | Automatic Selection | 170° C. | 15 | min |
| | Manuel Selection | 130° C.-210° C. | 1 min-60 min | |
| Yogurt Preparation | Automatic Selection | 45° C. | 8 | hours |
| | Manuel Selection | 35° C.-55° C. | 5 hours-10 hours | |
| Frying | Automatic Selection | 200° C. | 20 | min |
| | Manuel Selection | 150° C.-210° C. | 1 min-60 min | |
| Vegetable/Fruit Drying | Automatic Selection | 60° C. | 6 | hours |

| | | |
|---|---|---|
| Manuel Selection | 40° C.-90° C. | 1 hour-12 hours |

1. A hot air flow cooking appliance comprising a cooking chamber (4) in which the products to be cooked are placed, a fat collector (3) placed on the bottom of the cooking chamber (4) and a keypad (5) on which the cooking options are selected, characterized in that;
the pot (2) placed on the fat collector (3), in which the ingredients required for the preparation of stews and yogurt are added,
contains a controller that allows the operating temperature to be set to 150° C.-210° C., time interval 1-120 minutes for cooking stews and the operating temperature to be set to 35° C.-55° C., time interval 5-10 hours for yogurt preparation feature.

2. A hot-air cooking appliance according to claim 1, characterized in that it comprises a controller which activates the heater in the yogurt preparation function.

3. A hot-air flow appliance according to claim 1, characterized in that it comprises a lid (1) which covers the pot (2) placed inside the cooking chamber (4).

4. A hot-air cooking appliance according to claim 1, characterized in that it comprises a loudspeaker providing audible information about cooking operations.

5. A hot-air cooking appliance according to claim 1, characterized in that it comprises a screen on the keypad (5) for monitoring the cooking temperature and time.

6. A hot-air cooking appliance according to claim 1, characterized in that it comprises a keypad (5) for manually changing the temperature time setting by means of buttons located thereon.
